(19) United States
(12) Patent Application Publication
(10) Pub. No.: US 2012/0256598 A1
(43) Pub. Date: Oct. 11, 2012

(54) Battery Pack Detection Circuit

(75) Inventors: Hung An HSU, Chu Pei City (TW); Hui Te Hsu, Chu Pei City (TW)

(73) Assignee: NEOTEC SEMICONDUCTOR LTD., Chu Pei City (TW)

(21) Appl. No.: 13/441,597

(22) Filed: Apr. 6, 2012

Related U.S. Application Data
(60) Provisional application No. 61/457,483, filed on Apr. 8, 2011.

(51) Int. Cl. H02J 7/00

(52) U.S. Cl. 320/148

(57) ABSTRACT

A battery pack detection circuit that can detect cold or false welding, charging status, and discharging status is disclosed. The battery pack detection circuit comprises a driving circuit electrically connected to a switch unit outside the battery pack detection circuit; a voltage detection and comparison circuit electrically connected to a multi-cell battery pack having a plurality of battery cells outside the battery pack detection circuit, wherein the voltage detection and comparison circuit is configured to detect cell voltages across each of the battery cells under at least two circuit connection conditions and compare the differences in cell voltage with a predetermined value, wherein the differences in cell voltage are derived from a subtraction operation performed on the cell voltages measured under the at least two circuit connection conditions; and an interface and control unit configured to receive commands from a SMBUS and provide a signal to a detection load.

### CROSS REFERENCE TO RELATED APPLICATIONS

This application claims Priority from U.S. Provisional Application No. 61/457,483 filed on Apr. 8, 2011, which is incorporated by reference.

### BACKGROUND OF THE INVENTION

1. Technical Field

Embodiments of the present invention relate to battery pack detection circuits, and more particularly, to circuits for detecting cold or false welding, charging status, and discharging status in a multi-cell battery pack including a plurality of serial-connected battery cells.

2. Background

Rechargeable batteries are widely used in many applications to supply power for a variety of electronic devices. For example, portable devices such as cell phones, personal digital assistants (PDAs), laptops, and power tools use rechargeable batteries as a power source. The rechargeable batteries may be nickel-cadmium (NiCd), nickel-metal hydride (NiMH), or lithium ion (LiIon).

Large capacity rechargeable batteries generally comprise multiple cells connected in parallel to deliver the required current and in series to deliver the required voltage. The multiple cells are ordinarily packaged as a battery pack. In order to form the battery pack, multiple connections between positive and negative electrodes of the battery cells are required. FIG. 1 is a cross-sectional view showing the connections between the positive and negative electrodes of the battery cells. Referring to FIG. 1, multiple battery cells 12 are arranged in a row in an electrically insulating case (not shown). Each battery cell 12 has a positive electrode 14 on the top and a negative electrode 16 on the bottom. A connecting metallic plate 18 made of copper is disposed on both the positive electrode 14 of a battery cell 12 and the negative electrode 16 of another battery cell 12 to form a lap joint. Two welds 19 are formed on the top surface of each connecting metallic plate 18 on the positive electrode 14 side of one battery cell and two welds 19 are formed on the metallic plate 18 on the negative electrode 16 side of the other battery cell.

With this arrangement, there is a possibility of a cold welding condition or a false welding condition occurring at the welds 19, which can result in opening of the current loop in the battery pack. The cold welding condition and the false welding condition are difficult to detect after the battery pack is assembled. In addition, a weld of good quality may be damaged by an electric shock during shipping or maintenance. Therefore, there is a need to provide a circuit to solve the above-mentioned problems.

### SUMMARY

A battery pack detection circuit comprises a driving circuit electrically connected to a switch unit outside the battery pack detection circuit and configured to enable or disable a switch in the switch unit; a voltage detection and comparison circuit electrically connected to a multi-cell battery pack having a plurality of battery cells outside the battery pack detection circuit and configured to detect cell voltages across each of the battery cells under at least two circuit connection conditions and configured to compare differences in cell voltage with a predetermined value, wherein the differences in cell voltage are derived from a subtraction operation performed on the cell voltages measured under the at least two circuit connection conditions; and an interface and control unit connecting a system management bus (SMBUS) outside the battery pack detection circuit and a detection load outside the battery pack detection circuit, wherein the interface and control unit is configured to receive commands from the SMBUS and provide a signal to the detection load.

In regards to the operation of the battery pack detection circuit, the method comprises the steps of: detecting and recording cell voltages across each battery cell in the multi-cell battery pack as V1A to VkA when the switch unit and the switch in the detection load are disabled; enabling the switch in the detection load; detecting and recording cell voltages across each battery cell in the multi-cell battery pack as V1B to VkB when a switch in the switch unit is disabled and at least one switch in the detection load is enabled; performing a subtraction operation to obtain voltage values V1C to VkC, wherein V1C=V1A−V1B, and VkC=VkA−VkB; comparing each of the voltage values to a predetermined value; and setting a fault flag if one of the voltage values is greater than the predetermined value.

The foregoing has outlined rather broadly the features and technical advantages of the present invention in order that the detailed description of the invention that follows may be better understood. Additional features and advantages of the invention will be described hereinafter, which form the subject of the claims of the invention. It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

The objectives and advantages of the present invention are illustrated with the following description and upon reference to the accompanying drawings in which:

FIG. 1 is a cross-sectional view showing the connections between the positive and negative electrodes of the battery cells;

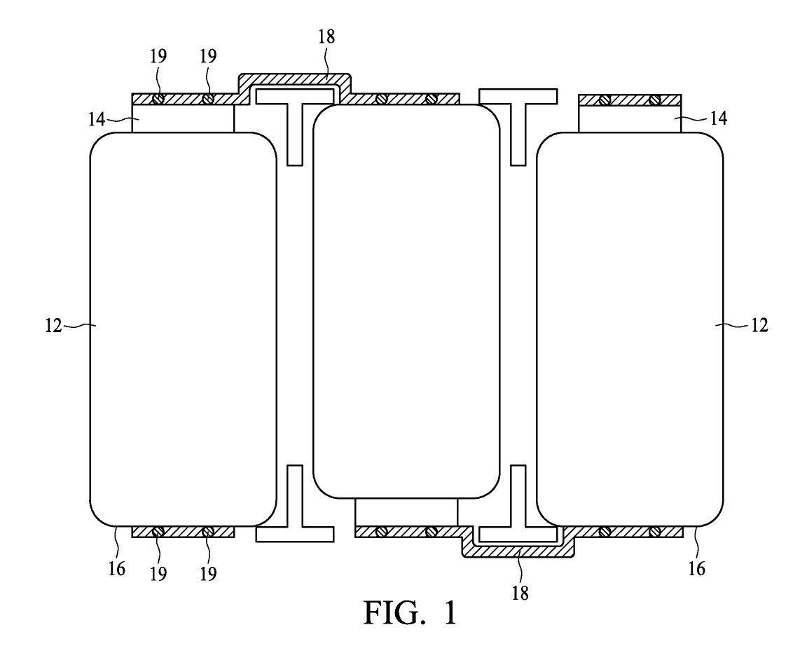

FIG. 2 is a block diagram of a battery system in accordance with an embodiment of the present disclosure;

FIG. 3 is a block diagram of a battery system in accordance with another embodiment of the present disclosure;

FIG. 4 is a block diagram of a battery system in accordance with another embodiment of the present disclosure; and

FIG. 5 is a block diagram of a battery system in accordance with yet another embodiment of the present disclosure.

### DETAILED DESCRIPTION

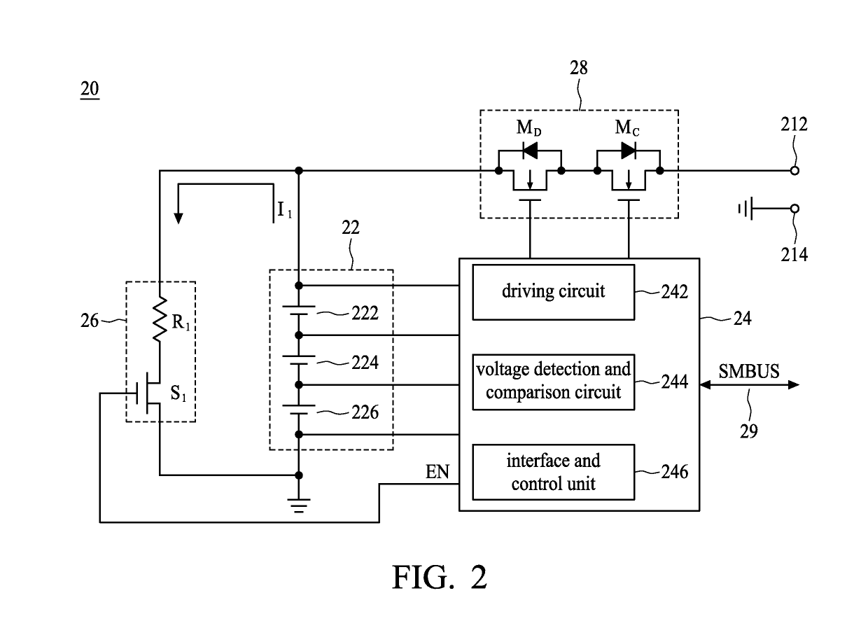

The disclosure relates to a battery pack detection circuit for a multi-cell battery pack. FIG. 2 is a block diagram of a battery system 20 in accordance with an exemplary embodiment. The battery system 20 includes a multi-cell battery pack 22, a battery pack detection circuit 24, a detection load 26, and a switch unit 28.

Referring to FIG. 2, a plurality of rechargeable battery cells 222, 224, and 226 are connected in series to form the multi-cell battery pack 22. A positive terminal and a negative terminal on the battery pack 22 are coupled to battery terminals 212 and 214 that are configured to provide current to operate a system load (not shown), such as a portable electronic device, and are configured to receive charge current from a power source (not shown), such as an AC/DC adapter.

The switch unit 28 of the battery system 20 includes two field effect transistors (FETs) M_{C} and M_{D} coupled in series between the battery pack 22 and the battery terminal 212.

The detection load 26 is connected in parallel with the battery pack 22. In one embodiment of the present disclosure, the detection load 26 comprises a resistor R₁ and a switch S₁ that are connected in series. When receiving an input signal EN, the switch S₁ turns on and a current I₁ is drawn from the battery pack 22.

Referring to FIG. 2, the battery pack detection circuit 24 comprises a driving circuit 242, a voltage detection/comparison circuit 244, and an interface and control unit 246. The driving circuit 242 is configured to provide driving signals and disable signals to the switch unit 28. The voltage detection/comparison circuit 244 is configured to detect the cell voltage across each of the battery cells 222 to 226 and then compare them to a reference voltage. The interface and control unit 246 is configured to receive commands from the SMBUS 29 and provide an enable signal EN to the detection load 26.

In operation, the voltage detection/comparison circuit 244 detects and records the cell voltage across each of the battery cells 222 to 226 as V1A, V2A, and V3A when the switch unit 28 and the switch S1 are disabled. Subsequently, the switch unit 28 remains off and the switch S1 turns on after receiving the enable signal EN from the interface and control unit 246. Next, the voltage detection/comparison circuit 244 detects and records the cell voltage across each of the battery cells 222 to 226 as V1B, V2B, and V3B.

The voltage detection/comparison circuit 244 performs a subtraction operation to obtain voltages V1C, V2C, and V3C, wherein voltages V1C=V1A-V1B, V2C=V2A-V2B, and V3C=V3A-V3B. After obtaining the voltages V1C, V2C, and V3C, the voltage detection/comparison circuit 244 compares each of them to a reference voltage VR to obtain a comparison value.

In one embodiment of the present disclosure, a cold welding condition occurs at the connection on one of the cells 222, 224, and 226. Therefore the voltages V1C, V2C, and V3C are greater than the reference voltage VR due to a high internal impedance of the battery pack 22. The voltage detection/comparison circuit 244 provides the comparison result to the driving circuit 242. Based on the comparison result, a fault flag can be set and the switch 28 remains disabled. The voltage detection/comparison circuit 244 also provides the comparison result to a host (not shown) over the SMBUS 29.

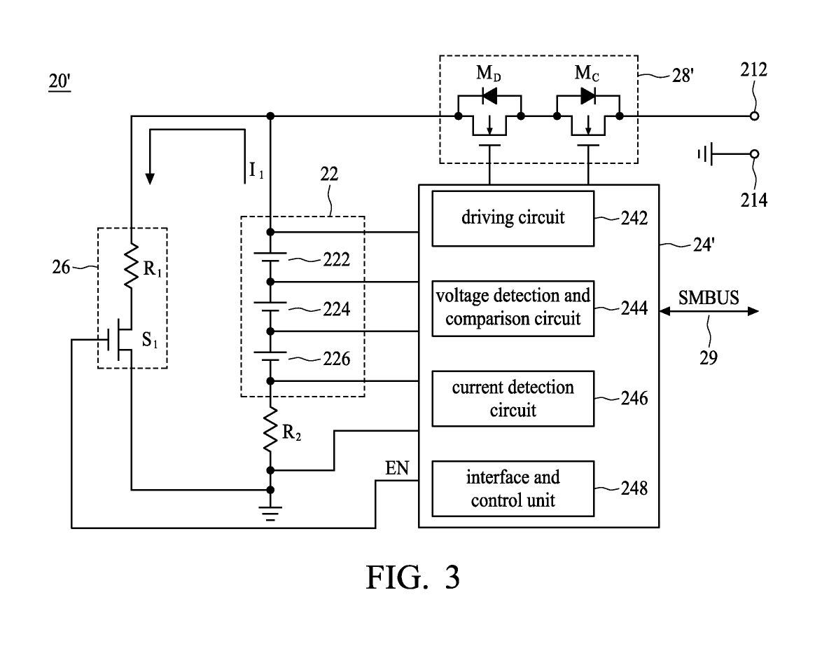

Referring to FIG. 3, a current sense resistor R₂ is added between the negative terminal of the battery pack 22 and ground. The battery pack detection circuit 24′ further comprises a current detection circuit 248 to monitor the charging current to the battery pack 22 by means of the current sense resistor R₂. Because the charging current varies over time, the voltage detection/comparison circuit 244 can compare the voltages V1C, V2C, and V3C with a threshold value in proportion to the charging current value to obtain a more precise comparison result.

When the battery pack 22 is used for long periods of time, the internal impedance of each of the battery cells 222 to 226 may vary. In one embodiment of the present disclosure, a storage element (not shown) is added to the battery pack detection circuit 24 to record the cell voltage across each of the battery cells 222 to 226 at different times. Therefore, if the cell voltage across one of the battery cells 222 to 226 exceeds a high threshold value, an alarm signal can be issued to the host over the SMBUS 29. In one embodiment of the present disclosure, a fault flag can be set when the cell voltage across one of the battery cells 222 to 226 exceeds the high threshold value.

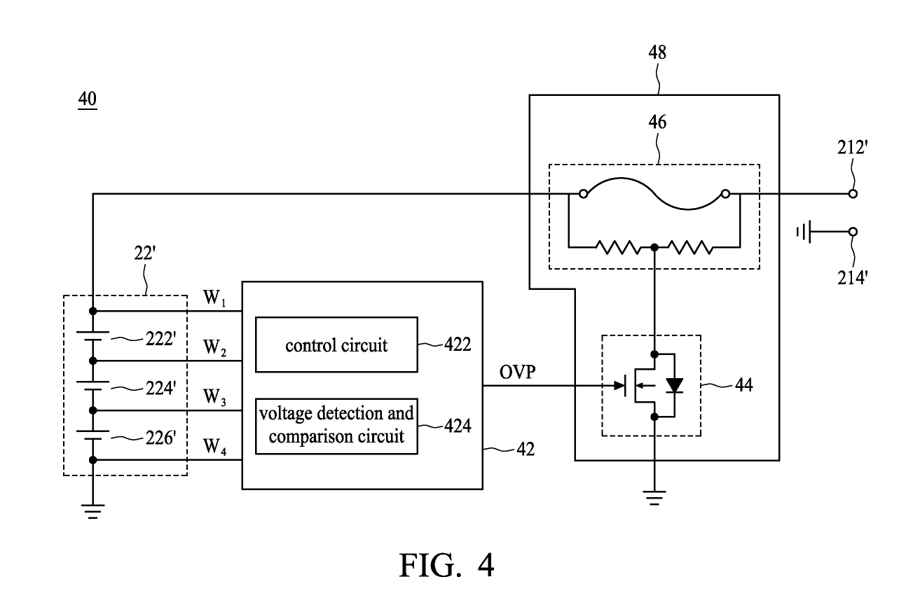

FIG. 4 is a block diagram of a battery system 40 in accordance with another embodiment of the present disclosure. Referring to FIG. 4, in which like elements of FIG. 2 are shown having like reference designations, the battery system 40 includes a multi-cell battery pack 22′, a battery pack detection circuit 42, a switch element 44, and a fuse element 46.

Referring to FIG. 4, a positive terminal and a negative terminal on the battery pack 22′ are coupled to battery terminals 212′ and 214′ that are configured to receive charging current from a power source (not shown), such as an AC/DC adapter. Because overcharging the battery pack 22′ can lead to explosion, flame or other hazardous situations, the battery pack detection circuit 42 is designed to prevent over-voltage charging of the battery pack 22′. The battery pack detection circuit 42 is configured to detect the cell voltage across each of the battery cells 222′ to 226′. If one of the detected cell voltages exceeds a predetermined threshold for a predetermined period of time, the battery pack detection circuit 42 will output a signal OVP as an over-voltage protection signal to the switch element 44. After receiving the signal OVP, the switch element 44 turns on and the fuse element 46 is opened, cutting off the charging current from the power source at the terminal 212′.

However, if one of the wires W₁, W₂, W₃, and W₄ between the battery pack 22′ and the battery pack detection circuit 42 fails to be connected, the battery pack detection circuit 42 cannot execute the OVP check function since the detected cell voltages are lower than the predetermined threshold in this condition. In such case, the battery pack 22′ is at risk of damage or explosion due to the excessively high voltage. To solve this problem, the battery pack detection circuit 42 is provided.

Referring to FIG. 4, the battery pack detection circuit 42 comprises a control circuit 422 and a detection/comparison unit 424. The control circuit 422 is configured to control the status of the switch element 44. The detection/comparison unit 424 is configured to detect the voltage at the positive terminal of the battery pack 22′ and the cell voltage across each of the battery cells 222′ to 226′.

In operation, when the detection/comparison unit 424 detects that the positive terminal of the battery pack 22′ and the battery pack detection circuit 42 are connected, the battery system 40 enters a detection mode. While in the detection mode, the battery pack detection circuit 42 performs a power on reset (POR) function and the comparison voltage of the detection/comparison unit 424 is reduced to a level that is below the lower limit voltage of the battery cell, such as 3V. The duration of time for which the battery system 40 is in the detection mode is fixed and constant. When the detection mode duration has passed, the battery system 40 changes modes from the detection mode to a normal mode, and the switch element 44 remains disabled if all wires W₁, W₂, W₃, and W₄ between the battery pack 22′ and the battery pack detection circuit 42 are connected.

However, if the detection/comparison unit 424 detects that the cell voltage across any one of the battery cells 222′ to 226′ is below the lower limit of the battery cell in the detection mode, the detection/comparison unit 424 will output a signal to the control circuit 422. After the battery system 40 enters the normal mode, the control circuit 422 outputs the signal OVP to the switch element 44, so the fuse element 46 is opened. In this manner, an open connection between the battery pack 22′ and the battery pack detection circuit 42 can be detected.

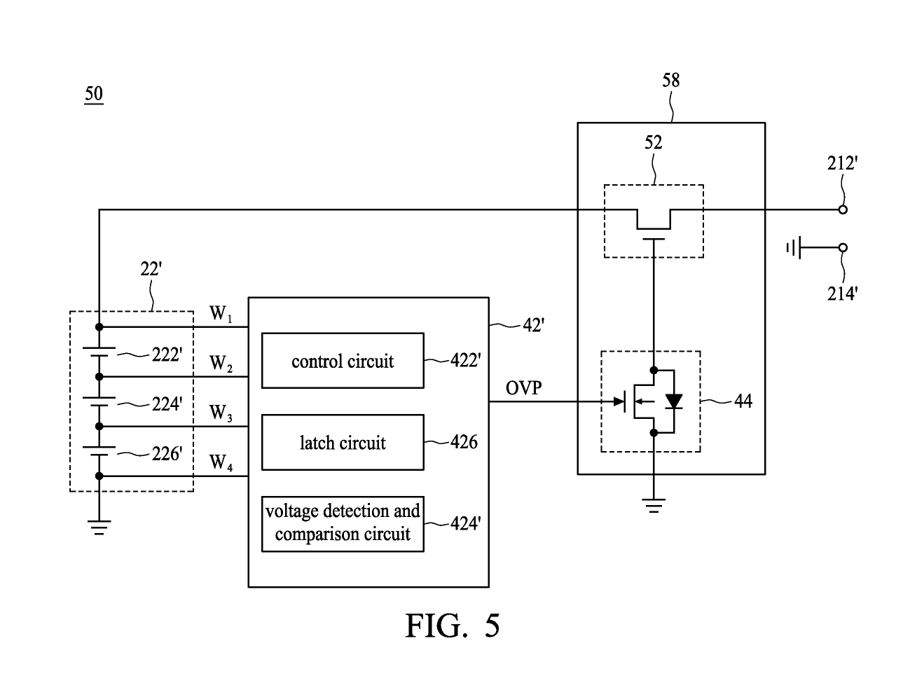

FIG. 5 is a block diagram of a battery system 50 in accordance with yet another embodiment of the present disclosure. Referring to FIG. 5, a latch circuit 426 is added between the detection/comparison unit 424′ and the control circuit 422′. The fuse element 46 is replaced with a switch element 52, such as an FET in this example. In one embodiment of the present disclosure, the latch circuit 426 is used to latch a signal from the detection/comparison unit 424′ when the detection/comparison unit 424′ detects that the cell voltage across any one of the battery cells 222′ to 226′ is below the lower limit of the battery cell in the detection mode. Therefore, the signal OVP remains at HIGH after the above condition occurs, and the switch element 52 remains disabled in the detection mode and the normal mode.

In another embodiment of the present disclosure, the latch circuit 426 is used to latch a signal from the detection/comparison unit 424′ when the detection/comparison unit 424′ detects that the cell voltage across any one of the battery cells 222′ to 226′ exceeds an upper limit of the battery cell (i.e., 4.4V) in the normal mode. In this condition, the signal OVP is issued, and the switch element 52 is switched off to prevent the battery pack 22′ from overcharging.

Although the present invention and its advantages have been described in detail, it should be understood that various changes, substitutions and alterations can be made herein without departing from the spirit and scope of the invention as defined by the appended claims. For example, many of the processes discussed above can be implemented in different methodologies and replaced by other processes, or a combination thereof.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A battery pack detection circuit, comprising:
a driving circuit electrically connected to a switch unit outside the battery pack detection circuit and configured to enable or disable a switch in the switch unit;
a voltage detection and comparison circuit electrically connected to a multi-cell battery pack having a plurality of battery cells outside the battery pack detection circuit and configured to detect cell voltages across each of the battery cells under at least two circuit connection conditions and compare the differences in cell voltage with a predetermined value, wherein the differences in cell voltage are derived from a subtraction operation performed on the cell voltages measured under the at least two circuit connection conditions; and
an interface and control unit connecting a system management bus (SMBUS) outside the battery pack detection circuit and a detection load outside the battery pack detection circuit, wherein the interface and control unit is configured to receive commands from the SMBUS and provide a signal to the detection load.

2. The battery pack detection circuit of claim 1, further comprising a current detection circuit configured to monitor a charging current to the multi-cell battery pack by a current sensing device inserted between a negative terminal of the multi-cell battery pack and a ground.

3. The battery pack detection circuit of claim 1, wherein the switch unit includes at least two field effect transistors coupled in series, the switch unit is connected to a terminal of the multi-cell battery pack, and each field effect transistor is electrically connected to the driving circuit.

4. The battery pack detection circuit of claim 1, wherein the detection load includes at least one current sensing device and at least one switch, and the detection load is connected to the multi-cell battery pack in parallel.

5. The battery pack detection circuit of claim 4, wherein one of the circuit connection conditions includes disabling all the switches in the switch unit and disabling all the switches in the detection load.

6. The battery pack detection circuit of claim 4, wherein one of the circuit connection conditions includes disabling all the switches in the switch unit and enabling all the switches in the detection load.

7. A battery pack detection circuit, comprising:
a control circuit electrically connected to a switch unit outside the battery pack detection circuit, wherein the control circuits configured to enable or disable a switch in the switch unit; and
a voltage detection and comparison circuit electrically connected to a multi-cell battery pack having a plurality of battery cells outside the battery pack detection circuit, wherein the voltage detection and comparison circuit is configured to detect cell voltages across each of the battery cells and compare cell voltages with predetermined voltage thresholds.

8. The battery pack detection circuit of claim 7 further comprising a latch circuit configured to latch a signal output from the voltage detection and comparison unit to the switch unit.

9. The battery pack detection circuit of claim 7, wherein the switch unit includes a field effect transistor and a fuse element connected in series and the switch unit is connected between a positive terminal of the multi-cell battery pack and a ground.

10. The battery pack detection circuit of claim 7, wherein the switch unit includes a field effect transistor and a switch connected in series and the switch unit is connected between a positive terminal of the multi-cell battery pack and a ground.

11. The battery pack detection circuit of claim 7, wherein the voltage thresholds include:
a minimum voltage of the battery cell; and
a maximum voltage of the battery cell.

12. A method for operating a battery pack detection circuit in a battery system, the battery system comprising:
a battery pack detection circuit;
a switch unit;
a multi-cell battery pack including a first to a k^{th} battery; and
a detection load including at least one current sensing device and at least one switch connected in series;
wherein the multi-cell battery pack and the detection load are connected in parallel such that when the switch in the detection load is enabled and any switch in the switch unit is disabled, a current is flowing from the multi-cell battery pack to the detection load; the multi-cell battery pack and the switch unit are connected in series; and the battery pack detection circuit is connected to each switch in the switch unit, the multi-cell battery pack, and the detection load; and
the method comprises the steps of:
detecting and recording cell voltages across each battery cell in the multi-cell battery pack as V1A to VkA when the switch unit and the switch in the detection load are disabled;
enabling the switch in the detection load;
detecting and recording cell voltages across each battery cell in the multi-cell battery pack as V1B to VkB when a switch in the switch unit is disabled and at least one switch in the detection load is enabled;
performing a subtraction operation to obtain voltage values V1C to VkC, wherein V1C=V1A-V1B, and VkC=VkA-VkB;
comparing each of the voltage values to a predetermined value; and
setting a fault flag if one of the voltage values is greater than the predetermined value.

13. The method for operating a battery pack detection circuit in a battery system of claim 12, further comprising the steps of:
monitoring a charging current to the multi-cell battery pack; and
adjusting the predetermined value in proportion to the monitored charging current.

14. A method for operating a battery pack detection circuit in a battery system, the battery system comprising:
a battery pack detection circuit;
a switch unit; and
a multi-cell battery pack including a first to a k^{th} battery;
wherein the multi-cell battery pack and the switch unit are connected in parallel, and the battery pack detection circuit connects to the switch unit and the multi-cell battery pack; and
the method comprises the steps of:
detecting and recording cell voltage values across each battery cell in the multi-cell battery pack;
comparing each of the voltage values to predetermined voltage thresholds; and
outputting a signal to the switch unit if one of the voltage values is greater than one predetermined voltage threshold or lower than another predetermined voltage threshold.

15. The method for operating a battery pack detection circuit in a battery system of claim 14, further comprising the steps of:
entering a detection mode wherein a power on reset function is performed and the predetermined voltage threshold is reduced to a first level below a minimum voltage of the battery cell;
remaining in the detection mode for a fixed duration;
entering a normal mode after the fixed duration wherein the predetermined voltage threshold is raised to a second level above a maximum voltage of the battery cell; and
outputting a signal to the switch unit if one of the cell voltages is lower than the first level or greater than the second level.

16. The method for operating a battery pack detection circuit in a battery system of claim 14, further comprising the step of:
latching a signal to the switch unit if one of the cell voltages is lower than the first level or greater than the second level.
